(19) United States
(12) Patent Application Publication
(10) Pub. No.: US 2023/0108355 A1
(43) Pub. Date: Apr. 6, 2023

(54) ROBOT SYSTEM WITH ELECTRONIC MANUAL

(71) Applicant: DENSO WAVE INCORPORATED, Chita-gun (JP)

(72) Inventor: Nao MATSUMURA, Chita-gun (JP)

(73) Assignee: DENSO WAVE INCORPORATED, Chita-gun (JP)

(21) Appl. No.: 17/960,641

(22) Filed: Oct. 5, 2022

(30) Foreign Application Priority Data
Oct. 5, 2021 (JP) 2021-164315

(51) Int. Cl. G06F 16/33; G06F 16/332; G06F 16/34; G06F 40/242; G06F 40/247; G06F 40/279

(52) U.S. Cl. CPC G06F 16/3344; G06F 16/3329; G06F 16/34; G06F 40/242; G06F 40/247; G06F 40/279

(57) ABSTRACT

A robot system has a teaching pendant with a display. The teaching pendant serves as an operation terminal for the robot system. An electronic manual is stored in the teaching pendant. A user's viewing operation enables the electronic manual to be displayed on the display. The electronic manual is described with a source code which includes text data to be displayed on the display and text data not to be displayed on the display. The text data not to be displayed consist of words or phrases associated with keywords included in the text data to be displayed. When a user's search specifies a word or phrase in the electronic manual, both text data are extracted from the source code to generate data for search, which are then subjected to search of the user's specified word or phrase.

### CROSS-REFERENCE TO RELATED APPLICATION

This application is based on and claims the benefit of priority from earlier Japanese Patent Application No. 2021-164315 filed Oct. 5, 2021, the description of which is incorporated herein by reference.

### BACKGROUND

### Technical Field

The robot system relates to a robot system, and in particular, to a robot system including an operation terminal equipped with a display that displays an electronic manual containing electronic information on the handling instructions of the robot system.

### Related Art

In recent years, there have been diverse types of robot systems accompanied by mechanisms to operate the robots.

One such system is equipped with a controller that controls the movement of an industrial robot, as well as an operation terminal such as a teaching pendant that is used to set the operation sequence of the industrial robot. In this type of robot system, it is known to be equipped with an electronic manual that provides various types of information such as the configuration of the robot system, operation methods, and maintenance methods, i.e., information on handling instructions in electronic form (see, for example, Patent Document 1). In the configuration described in this Patent Document 1, a technology is proposed to display an electronic manual on the display screen of an operation terminal or other devices. Electronic manuals can be viewed at the operation terminal, improving convenience when operating the robot system.

### Patent Documents

[Patent Document 1] JP-B-6079561

On the other hand, in recent years, robot systems have become more sophisticated and multifunctional. As a result, the volume of information in the instruction manuals for such robot systems tends to increase. Therefore, when a user tries to find the information that meets user's purpose while scrolling through the pages of an electronic manual, the time and effort required to find the information increases. Therefore, in order to further improve convenience of the operations of the robot system, the inventor of this application has devised a configuration that allows the user to search for a specified word or phrase in the electronic manual.

### Problems to Be Solved

Here, some of the various components that make up a robot system are referred to by technical terms and other special terminology.

However, the terminology is not always widely uniform among manufacturers (in the robot industry). For example, the operation terminal described above is sometimes called a teaching pendant, but may also be referred to as a T-pen or an operation panel. Of course, it is possible to envision an electronic manual in which the system or component is described using only one term (e.g., teaching pendant) out of several related terms. However, in that case, it is also assumed that a search operation is performed by specifying a term (e.g., T-pen) other than that one term (e.g., teaching pendant), as a search candidate (search keyword). In the case of this search, there may be an event in which the candidate does not hit the search. In other words, even though the electronic manual contains information that matches the user's purpose, the information may not be searched (omission of search). Such an inconvenience can also occur when the electronic manual contains related content (sentences) related to the term in question, rather than the one term above itself. Thus, there is still room for improvement in existing robot systems from the viewpoint of improving convenience when operating the robot system.

The present invention has been made in view of the above issues. The main purpose of the present application is to prevent or reduce search omissions (or failures in search) in the electronic manuals used when operating the robot system, and to improve the convenience of operating the robot system.

### SUMMARY

The following is a description of the means to solve the above issues.

A first exemplary embodiment provides a robot system, comprising:

an operation terminal, the operation terminal having a display and a controller, the display displaying an electronic manual based on a viewing operation of a user, the electronic manual being an instructional information for the robot system,

wherein the electronic manual is expressed and stored by a source code written in markup language, the source code including i) text data subject to display, which consists of words or phrases to be displayed on the display by the viewing operation, and ii) text data not subject to display, consisting of related words or phrases associated with specific words or phrases included in the text data subject to display, the text data not subject to display being not displayed on the display by the viewing operation, and

the controller is configured to, when a user of the robot system performs a search operation for a specified word or phrase on the electronic manual, i) extract data for search from the source code, the data for search including the text data subject to display and the text data not subject to display, ii) search the data for search for the specified word or phrase, and iii) display a result of the search on the display.

The source code for the electronic manuals is described in markup language. The source code includes text data to be displayed during viewing and text data not to be displayed during viewing. When the user performs a search operation for a word or phrase, the word or phrase specified by the user is searched from the search data, which consists of text data to be displayed and text data not to be displayed extracted from the source code. The various configurations of the robot system are called by special terms such as technical terms (equivalent to specific words or phrases in the text data to be displayed). ere is not necessarily widespread uniformity regarding the terminology concerned. For the above text data not to be displayed, the text data consists of related words or phrases associated with the above specific words or phrases. Even if the user specifies not a specific word or phrase but a related word or phrase as a search candidate, the related word or phrase will be included in the search data. It is possible to prevent or reduce the omission of such words from the search. In other words, it solves the problem of information that is omitted from searches even though the electronic manual contains information that meets the user's objectives. For these reasons, it can contribute to further improvement of the convenience of the robot system.

It is noted that the text data not subject to display will not be displayed when viewing the electronic manual. This avoids making the electronic manual difficult to read when viewing or browsing, even if the source code is configured to include the relevant words or phrases.

A second exemplary embodiment provides a robot system, comprising:

an operation terminal, the operation terminal having a display, the display displaying an electronic manual based on a viewing operation of a user, the electronic manual being an instructional information for the robot system,

wherein the electronic manual is expressed and stored by a source code written in markup language, the source code including i) text data subject to display, which consists of words or phrases to be displayed on the display by the viewing operation, and ii) text data not subject to display, consisting of related words or phrases associated with specific words or phrases included in the text data subject to display, the text data not subject to display being not displayed on the display by the viewing operation, and

the operation terminal comprises data generating means for extracting both the text data subject to display and the text data not subject to display, from the source code of the electronic manual and generating data for search;

search means for searching the data for search, for a word or phrase specified by a user, when the user performs a search operation for the word or phrase in the electronic manual; and

report means for reporting a search result performed by the search means, to the user by displaying the search result on the display.

According to the search system shown in the second exemplary example, the same effect as in the first exemplary example can be expected. In other words, it prevents or reduces the problem of information being omitted from a search even though the electronic manual contains information that meets the user's objectives. It can contribute to further improvement of the convenience of the robot system. In addition, because search data is generated from the electronic manuals as needed, there is no need to separately prepare search data in the ROM of the operation terminal or other memory devices. In this way, the increase in data volume can be suppressed, which is desirable for coexistence with other functions in the operating terminal (e.g., the robot motion setting function). If the electronic manuals are revised in accordance with updates to the robot system, the revised results will be reflected in the inspection data generated from the electronic manuals. This is desirable for proper search (retrieval) corresponding to the version of the robotic system and electronic manuals.

### BRIEF DESCRIPTION OF THE DRAWINGS

In the accompanying drawings:

FIG. 1 is a block diagram showing an outline of a robot system employed in a first embodiment;

FIG. 2 is an outlined illustration explaining a viewing screen of an electric manual;

FIGS. 3A and 3B are illustrations outlining search screens which appear in sequence in performing search operations;

FIG. 4 is a flowchart outlining search processes executed by a CPU of a teaching pendant;

FIG. 5A is an outlined view exemplifying an electronic manual which are now viewed;

FIG. 5B is a view exemplifying a source code of a part of the electronic manual;

FIG. 6 is an outlined view exemplifying special tags;

FIG. 7 is an outlined illustration showing the special tags;

FIG. 8 is an outlined illustration exemplifying keywords and related words or phrases thereto;

FIG. 9 is a view exemplifying data for search;

FIG. 10 is an outlined view exemplifying a search result;

FIG. 11 is an outlined view exemplifying data for search in a second embodiment;

FIG. 12 is an outlined view showing special tags used in a third embodiment;

FIG. 13A is an outlined view exemplifying an electronic manual which are now viewed, in a fourth embodiment; and

FIG. 13B is a view exemplifying a source code of a part of the electronic manual.

### DETAILED DESCRIPTION OF THE PREFERRED EMBODIMENTS

### First Embodiment

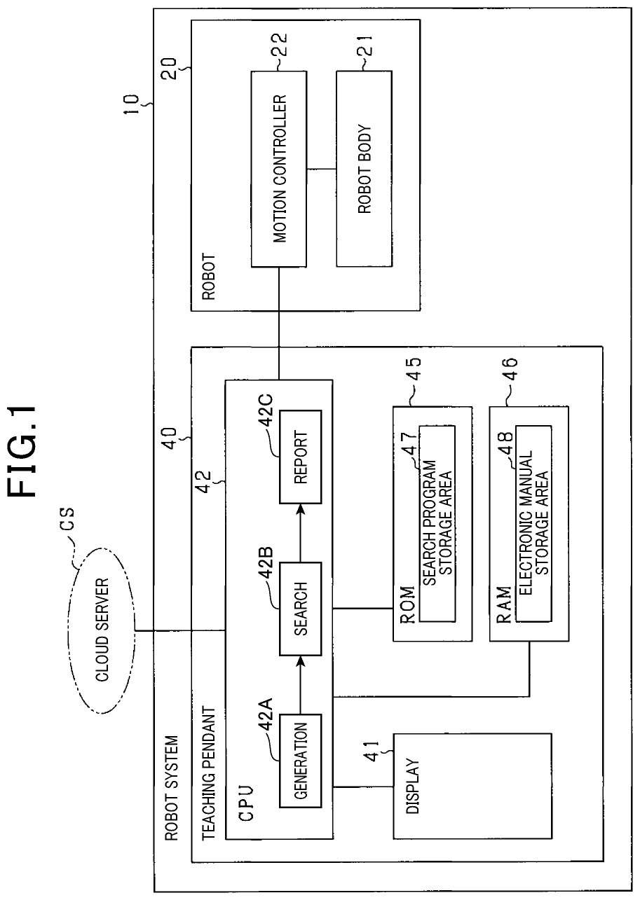

The following is a description of the first embodiment of an industrial robot system for use in machine assembly plants, etc., with reference to the drawings. First, an overview of the industrial robot system is given in FIG. 1.

A robot system 10 in this embodiment has a robot 20 and a teaching pendant 40, which is an operation terminal for the robot 20. The robot 20 is equipped with a robot body 21, which is a horizontally articulated (4-axis in detail) industrial robot, and a motion controller 22 (hereinafter referred to as a controller 22) that controls the robot body 21.

As is known, the robot body 21 has a base, an arm attached to the base, a hand (tool) at the end of the arm, and a servo amplifier that drives the arm and hand. The arm has a plurality of movable sections and one or more indirect sections that interconnect these movable sections. Each joint is equipped with a motor that drives the moving part and an encoder that detects the rotation angle of each motor. The servo amplifier has drive circuits that drive the motors for each joint based on drive commands from the motion controller 22 and detection information such as rotation angle detected by the encoder.

The motion controller 22 is connected to the teaching pendant 40 via a communication cable. The teaching pendant 40 is a portable operating terminal with a touch-screen display 41. The teaching pendant 40 has CPU 42 as a control unit which is a computer, ROM 45 (corresponding to a non-transient computer-readable recording medium) and RAM 46 as memory units. In addition, programs for various applications, including setting support applications, are installed on the teaching pendant 40. CPU 42 executes those applications based on user operations.

If a configuration support application is used by the user, a configuration support screen is displayed on the display 41, and CPU 42 sets the sequence of operation of the robot 20 based on user operation. The set sequence of operations is transmitted to the controller 22. The motion controller 22 has a program bank that stores various motion programs for the robot. The control section of controller 22 reads the motion program corresponding to the motion sequence received from the teaching pendant 40 from the program bank, determines drive commands based on the read motion program, and sends the determined drive commands to the servo amplifier.

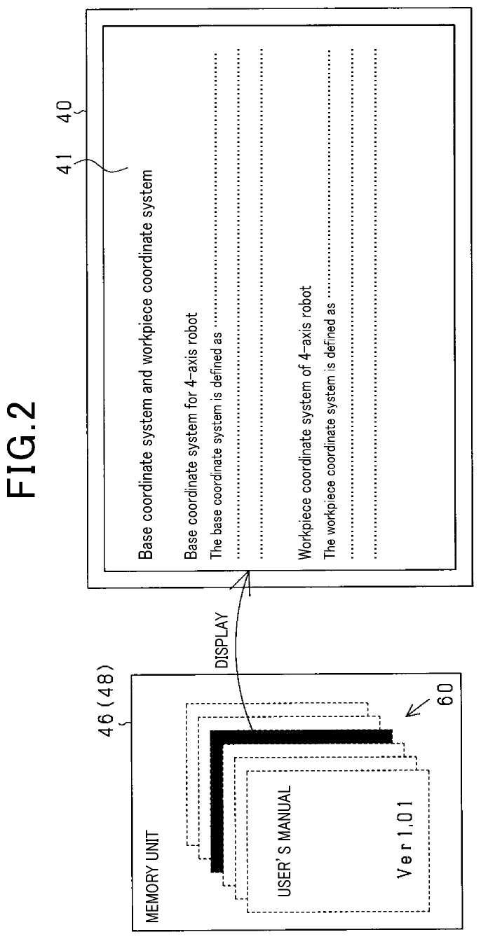

As one of the above applications, a manual viewing application is installed on the teaching pendant 40 for viewing the instructional information of the robot system 10. When this manual viewing application is used, a viewing screen for the electronic manual is displayed on the display 41, as illustrated in FIG. 2. Specifically, RAM 46 has an electronic manual storage area 48 that stores an electronic manual 60, which is a computerized version of the above instruction information. Therefore, the electronic manual 60 is stored in the storage area 48 when the teaching pendant 40 is manufactured.

For the electronic manual 60, for example, it is revised to the latest version in accordance with updates to the robot system 10, and the latest version is uploaded to the cloud server CS. The teaching pendant 40 can be connected to the cloud server CS via the Internet. Thus, the revised electronic manual 60 is downloaded from the cloud server CS to the teaching pendant 40 in response to events such as user update operations. This updates (overwrites) the electronic manual 60 stored in the electronic manual storage area 48 to the latest version. The electronic manual 60 installed on the teaching pendant 40 can be updated in various ways. For example, it may be updated using a CD-ROM or other media (storage medium).

Here, the source code of the electronic manual 60 shown in this form is written in markup language (specifically, html format). The teaching pendant 40 also has a browser installed. Thus, when the user operates to view the electronic manual 60, the specified page is displayed on the display 41 by the browser. On the viewing screen where the electronic manual 60 is displayed, the page being displayed can be changed by sliding the finger touching the display 41 up or down.

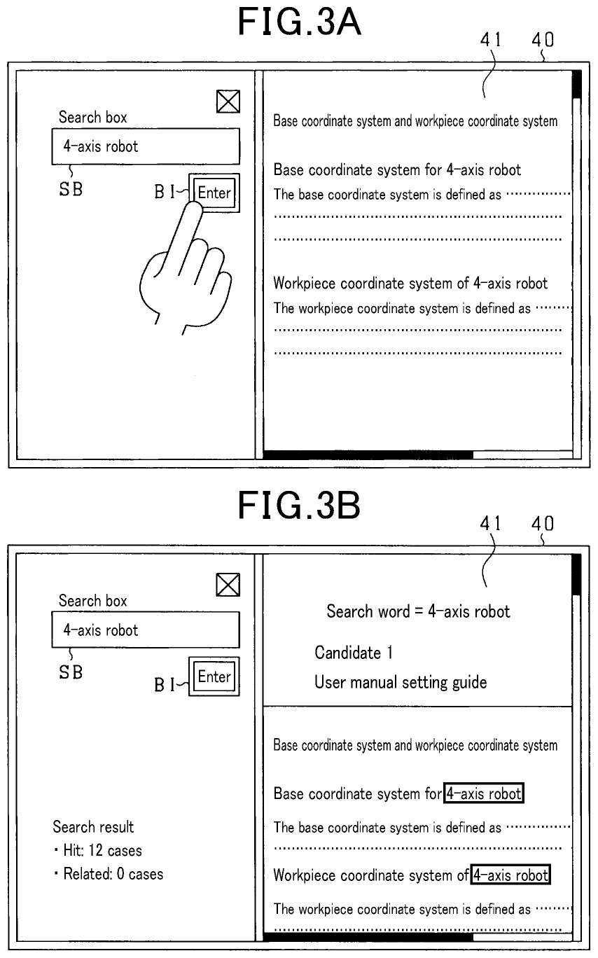

The electronic manual 60 consists of several files, including a table of contents, an initial setup guide, an operating sequence setup guide, a maintenance guide, and a Q&A. Therefore, the amount of information (number of characters and pages) is usually enormous. One of the features of the robot system 10 in this embodiment is to support the user's search (retrieval) for the desired word or phrase from the electronic manual 60, taking this situation into consideration. Specifically, it has a function to search (retrieve) for a word or phrase desired by the user from the electronic manual 60 using a search program stored in a search program storage area 47 of ROM 45, and to inform the user of the search results. The functions are described below with reference to FIGS. 3A and 3B.

In the electronic manual 60 viewing screen, a list of user-selectable operation items (operation menu) is displayed when any position on the display 41 is pressed and held. These operation items include “word search,” and when the user selects this “word search,” the screen switches from the browsing screen to the search screen.

Specifically, in response to the long press, as shown in FIG. 3A, in the search screen, the display area of display 41 is bisected into a manual display area for continuing the display (viewing display) of the electronic manual 60 and a search information display area where a search box SB for specifying words to be searched and an execution button BI to execute a search for the specified word or phrase are displayed. After switching to the search screen, the user enters a word or phrase to be searched in the search box SB and taps the execution button BI to start searching for the word or phrase.

After the search is completed, the results of the search are reported to the user, as shown in FIG. 3B. Specifically, in the search area, the number of hits for the entered word or phrase (specified word or phrase) is displayed, and in the manual display area, the location (i.e., address) of the word or phrase is displayed. This location display information includes the display of the name of the file containing the relevant phrase in the electronic manual 60, the display of the page containing the phrase, and the highlighting of the words on the displayed page that were hit by the search. In FIG. 3B, the highlighting display is used by a square enclosing display of the hit word or phrase, instead.

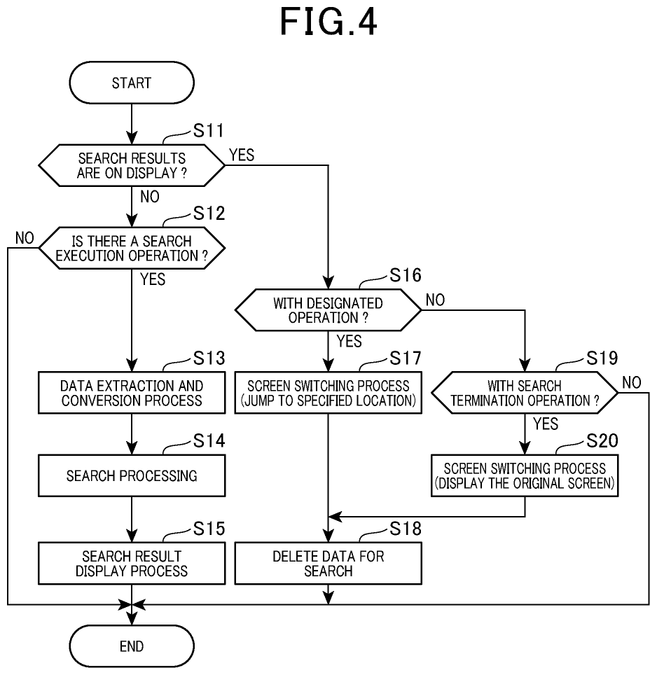

Next, referring to the flowchart in FIG. 4, the process for search executed by CPU 42 is described. The process for searching is performed as part of the process that is periodically executed during the startup of the manual browsing application described above, or more specifically, during the display of the search screen.

In the CPU 42 first determines whether or not the search results are being displayed in step S11. CPU 42 makes a negative judgment in step S11 if the search results are not being displayed, and proceeds to step S12. In step S12, the presence or absence of a search execution operation (start operation) is determined, i.e., whether or not the execution button BI is tapped. If the CPU 42 judges NO in step S12, it ends this process for search as it is. Conversely, if the execution operation is determined to have been performed in step S12, CPU 42 makes a positive determination in step S12 and proceeds to step S13. In step S13, the process of generating data for search (retrieval) is executed. Specifically, CPU 42 extracts text data, etc. from the source code of the electronic manual 60 stored in the electronic manual storage area 48 of RAM 46, and converts the extracted data to JavaScript (registered trademark) format data. CPU 42 then stores the converted data, i.e., the data for search, in RAM 46. The details of the data for search are described below.

After the data for search is generated, CPU 42 executes the search process to retrieve the words or phrases specified by the user from said data for search (Step S14). In this search process, the number of words that match the specified words (number of hits) and the location of those words are identified and stored in a buffer in CPU 42. In step S15, CPU 42 executes the search result display process to inform the user of the results of the search process in step S14. In the search result display process, the number of hits and their location information for the specified words or phrases are displayed on the display 41 to inform the user (see FIG. 3B).

On the other hand, if it is determined in step S11 that the search results are being displayed (YES), CPU 42 advances the process to step S16. In step S16, CPU 42 determines whether any of the highlighted targets has been specified by the user, specifically, whether it has been tapped. If YES is determined in step S16, the process proceeds to step S17. In step S17, CPU 42 switches from the search screen to the browse screen. This causes the entire display 41 to show the electronic manual 60. In this case, the page is headed so that the word tapped by the user is positioned at the top of the display 41. The process then proceeds to step S18, where the data for search stored in RAM 46 is deleted, and this process for search is terminated. At this time, the information pertaining to the search results is also deleted, and the displayed search results are no longer displayed.

Furthermore, if step S16 NO is determined, the process proceeds to step S19. In step S19, CPU 42 determines whether a search termination operation is performed by the user. Specifically, it is determined whether or not the end button displayed in the search area has been tapped. If this search termination operation is not performed, the process for this search is terminated as it is. However, if the search termination operation is performed, CPU 42 proceeds to step S20 to switch from the search screen to the browse screen. This returns the entire display 41 to the state in which the electronic manual 60 is displayed, in detail, before switching to the search screen. After that, the process proceeds to step S18, where the data for search stored in RAM 46 is erased and this process for search is terminated. At this time, information on search results stored in the buffer is also deleted.

Incidentally, in the foregoing processes explained with FIG. 4, the process of step S13 functionally serves as data generating means (or data generating unit), the process of step S14 functionally serves as search means (or search unit), the process of S15 functionally serves as report means (or report unit). These functional means or units can be illustrated in FIG. 1, and also should be understood with combinations with the other steps shown in FIG. 1.

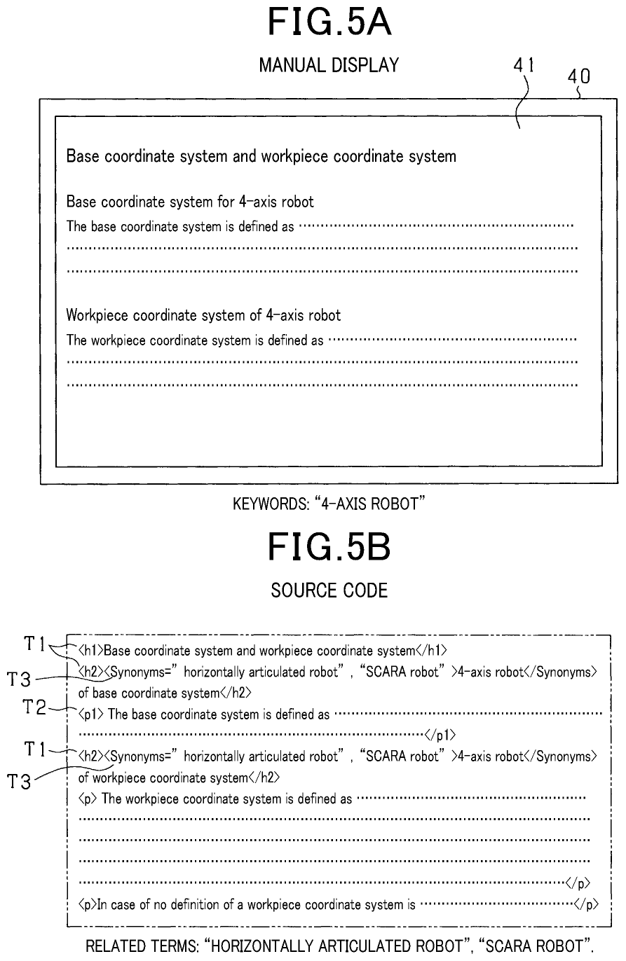

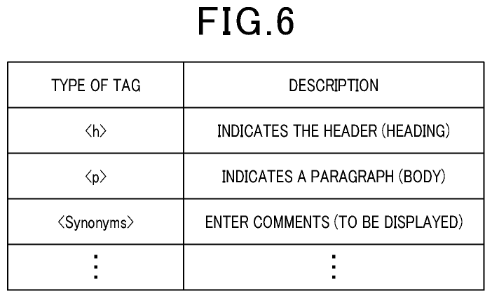

The various configurations that make up a robot system have technical terms and other special terminology, but such special terminology is not always widely uniform. For example, it is assumed that the system, etc., is explained using one of several related terms in the electronic manual being viewed. In such a case, if a user specifies another term among multiple related terms as a search candidate and performs a search operation, it is possible that the candidate will not be a hit in the search. In other words, although the electronic manual contains information that matches the user's search purpose, such information may be omitted from the search (search omission). This is not desirable for improving the convenience of the robot system. On the other hand, in the case of a manual that simply lists these multiple terms side by side, while this can reduce omissions from searches, it also makes it difficult to read the electronic manual when viewing it. Therefore, this is not conducive to user convenience. One of the features of this embodiment is that it takes these circumstances into consideration and is designed to control search omissions and improve convenience. The following is a supplemental explanation of the electronic manual 60 with reference to FIGS. 5A, 5B and 6, followed by a description of the above devices.

The source code for the electronic manual 60 shown in this form is in html format. The structure of the text (headings, body text, etc.) when viewing this source code is defined by tags (see FIGS. 5A, 5B). Tags that specify such sentence structure (hereinafter referred to as “structure tags”) include, for example, a header tag T1 serving as a first tag, which indicates the heading (header) of a sentence, and a paragraph tag T2 serving as a second tag, which indicates the body (paragraph) of a sentence (see FIG. 6).

The header tag T1 consists of <h> as the start tag and </h> as the end tag. When viewing the electronic manual 60, the text data sandwiched between these start and end tags is displayed in larger font than the main text as headings. The paragraph tag T2 consists of <p>, which is the start tag, and </p>, which is the end tag. When viewing the electronic manual 60, the text data sandwiched between these start and end tags is displayed in small characters as the main body. In other words, when viewing and displaying the electronic manual 60, the CPU 42 (browser) of the teaching pendant 40 identifies the text data tagged with (or embedded by) each structural tag as the display target, and identifies the text size, etc. based on the type of structural tag.

The source code of the electronic manual 60 shown in this form includes a special tag T3 (serving as a third tag) as a tag other than the structure tags described above. This special tag T3 is similar to the structure tag in that the tag T3 is able to tag text data. However, the CPU 42 (browser) of the teaching pendant 40 is configured to remove some of the text data tagged with this special tag T3 from the display, i.e., not to be displayed, when viewing and displaying it.

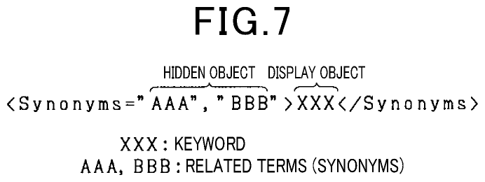

A supplementary explanation of special tag T3 is provided with reference to FIG. 7. The special tag T3 consists of a start tag, <Synonyms=“ ”>, and an end tag, </Synonyms>. The keywords described above are placed between the start and end tags. Between a pair of double-quotation marks in the start tag, a word or phrase related to the keyword in question (related phrase) is placed. In this form, a related phrase is any of the synonyms, synonyms and abbreviations of the keyword.

The number of related phrases placed within the start tag is arbitrary. A double-quotation mark is assigned to each related phrase. Related words or phrases enclosed in double-quotation marks can be written side by side, separated by commas. For example, if “XXX” is set as a keyword and “AAA” and “BBB” are set as its related terms, the source code is expressed as <Synonyms=“AAA”, “BBB”>XXX</Synonyms> (see FIG. 7).

The keywords sandwiched between the start and end tags that make up special tag T3 are the target of display when viewing and displaying the electronic manual 60. On the other hand, related words or phrases placed within the start tag are not subject to display when viewing and displaying the electronic manual 60. In this form, the relevant keywords correspond to “text data to be displayed” and the relevant phrases correspond to “text data not to be displayed”.

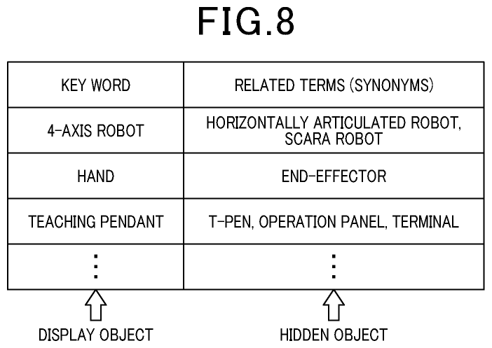

Referring now to FIGS. 5A, 5B and 8, the relationship between keywords and related phrases is illustrated. As mentioned above, in the robot system 10 shown in this embodiment, the robot 20 is a 4-axis horizontally articulated robot. The electronic manual 60 of the robot system 10 uses the term “4-axis robot” to refer to the robot 20 (see FIG. 5A). This robot 20 may be called a “horizontal articulated robot” or a “SCARA robot” in addition to a “4-axis robot”. In other words, the robot 20 can be referred to as a “4-axis robot,” “horizontally articulated robot,” or “SCARA robot”.

If those three designations were displayed in parallel on the viewing screen, there is concern that the electronic manual 60 would be difficult to read when viewing. In this regard, this form eliminates such concerns by applying the following source code to the paragraph containing such keywords. In other words, when the phrase “4-axis robot” is specified as text data to be displayed, the phrases “horizontally articulated robot” and “SCARA robot” are set as text data not to be displayed. For this setup, the source code is described as <Synonyms=“Horizontal Articulated Robot”, “SCARA Robot”> 4-axis robot </Synonyms>. As a result, although “Horizontally Articulated Robot,” “SCARA Robot,” and “4-axis Robot” are listed side by side in the source code, only “4-axis Robot” is displayed when viewed.

Examples of other keywords are also given below. For example, the display target text data “hand” is associated with the display non-target text data “end effector” by the above special tag T3. The text data to be displayed, “teaching pendant,” is associated with the text data not to be displayed, “T-pen,” “operation panel,” and “terminal,” by the special tag T3.

Here is a supplementary explanation of the creation (or generation, production) of data for search (step S13) in the process for search in FIG. 4. When generating data for search, structure tags are identified from the electronic manual data, and the text data contained in the structure tags (text data to be displayed) is extracted. In other words, the structural tag serves as an indicator of extraction.

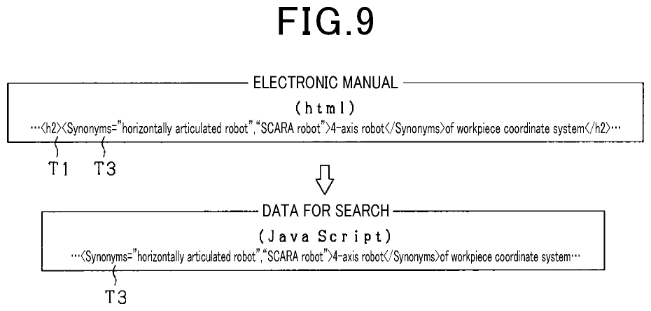

Some of those structure tags, i.e., structure tags that contain the above keywords in the stored text data to be displayed, are juxtaposed with related terms using the special tag T3 described above. In this case, as shown in FIG. 9, the text data to be displayed and the text data not to be displayed tagged with the special tag T3 are extracted by the same special tag T3 while maintaining their positional relationship. As a result, not only the text data to be displayed, but also its related words or phrases that are not to be displayed are extracted for each special tag. Therefore, those text data are converted to JavaScript (registered trademark) format. In other words, the data for search includes not only text data to be displayed but also text data not to be displayed. Furthermore, the special tag T3 can identify which words are keywords and which words are related to the keywords. By configuring the system in this way, related terms that are not displayed when browsing can also be included in the search target.

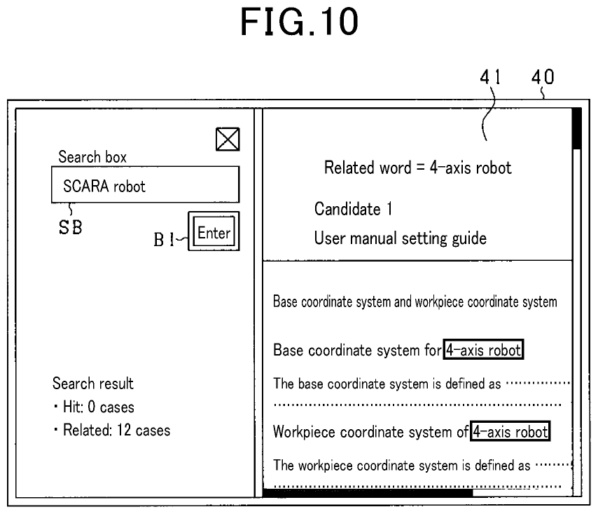

Next, referring to FIG. 10, this section describes how search results are reported (informed) when a related phrase, rather than a keyword, is specified by the user as a search term.

If a word or phrase specified by the user matches a related word or phrase, the number of hits for the related word or phrase is taught as a search result. In addition, keywords, which are words associated with the specified phrase, are taught. Specifically, if the above special tag T3 (in detail, the start tag), which constitutes the data for search, contains a word or phrase specified by the user, the word or phrase sandwiched between the start and end tags of the special tag T3 is identified and taught as the word or phrase associated with the specified word or phrase. In addition, the location of the words or phrases will be taught.

In the example shown in FIG. 10, the term “scalar robot” is specified by the user as the term to search. As a result of the search, the number of hits for “SCARA Robot” (i.e., the number of times the relevant “SCARA Robot” associated keyword appears) is taught. In addition, the keyword “4-axis robot” is taught, with “SCARA robot” being the associated keyword. Then, “4-axis robot” is highlighted to emphasize the keyword, and its location is taught.

According to this first embodiment, the following excellent effects can be expected.

When browsing and displaying, words or phrases related to the displayed keywords may be specified by the user as search candidates, instead of the displayed keywords. Even in such a case, the related phrase will be included in the search data, reducing the possibility that the phrase will be omitted from the search. In other words, it reduces the possibility that the electronic manual 60 contains information that meets the user's objectives, but that information is omitted from the search. For these reasons, the convenience of operating the robot system 10 can be further improved.

According to this example, there is no need to repeat the by designating multiple designations as candidates in order, and search omissions can be prevented or reduced. This ensures that the burden on the user at the time of search can be suitably reduced.

The related words or phrases are not subject to display when viewing the electronic manual 60. This avoids the situation where the electronic manual 60 becomes difficult to read when browsing, even if it is configured to embed the relevant words or phrases in the source code.

In addition, data for search is generated from the electronic manuals 60 as needed. Therefore, there is no need to separately prepare data for search in the ROM of the teaching pendant 40 or other devices. This reduction in the amount of data is desirable for coexistence with other functions in the teaching pendant 40 (e.g., the function for setting the sequence of operation). If the electronic manual 60 is revised in accordance with updates to the robot system 10, the revised results are also reflected in the inspection data generated from the electronic manual 60. This is desirable for proper search corresponding to the version of the robot system 10 and the electronic manual 60.

It is possible to identify text data for display and text data not for display in the data for search. This makes it possible to identify the affiliation of the hit phrase from the search, i.e., to which of the text data to be displayed or not to be displayed belongs. This is desirable to achieve a structure that appropriately informs the user of the search results.

When the search results are reported, the location of the word or phrase in the electronic manual 60 is taught to the user if the word or phrase displayed during browsing hits the search. However, if a word or phrase that is not displayed when browsing hits the search, the user is told the location of the word or phrase associated with that word or phrase in the electronic manual 60. This dramatically improves the convenience of the search function.

### Second Embodiment

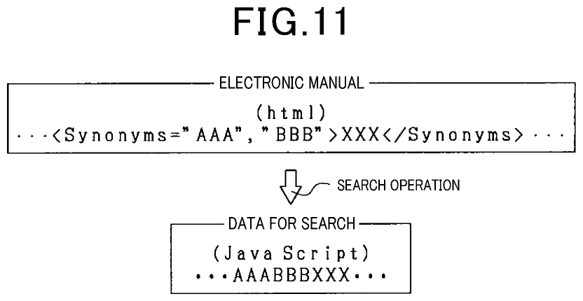

FIG. 11 illustrates the second embodiment.

In the first embodiment above, when generating data for search, the keywords (text data to be displayed) and their related terms (text data not to be displayed) tagged with the special tag T3 from the source code of the electronic manual 60 are configured to be extracted for each special tag T3. Furthermore, this extracted special tag T3 was configured to be used as a means of identifying keywords and related terms. In this second embodiment, the configuration pertaining to extraction when generating data for search differs from that of the first embodiment. Referring to FIG. 11 below, the configuration for such extraction will be explained, focusing on the differences from the first form.

In this second embodiment, it is characterized by a configuration that extracts keywords and related phrases stored in special tag T3 from the source code of the electronic manual 60 in an attempt to generate data for search. In the case of this extraction, the special tag T3 itself is set to be excluded from the extraction. In other words, when extracting the structural tag that contains the special tag T3, the keywords and related terms are extracted, while the special tag T3 itself is not extracted.

When generating data for search from the extracted data, the front-back positional relationship between keywords and related terms is maintained. In other words, in the search data, the related terms and keywords are arranged so that the related terms are in the front and the keywords are in the back.

In this embodiment, when generating data for search, information indicating the correspondence relationship between text data to be displayed (keywords) and text data not to be displayed (related terms) (correspondence information) is stored in RAM 46 as a separate file. The CPU 42 of the teaching pendant 40 can refer to this correspondence information to ascertain the correspondence relationship between keywords and related phrases after the fact.

If the word or phrase specified by the user in the word search is a related word or phrase, the above correspondence information is referenced to identify the keywords to which the related word or phrase corresponds. Furthermore, when teaching the location mentioned above, the identified keywords are searched again and the keywords are highlighted (for example, displayed by a square enclosure and/or coloring).

When using the electronic manual 60 to search for a word or phrase, it is assumed that the desired word or phrase is likely to be specified after a hit on the word or phrase used in that electronic manual 60. When using data for search to search for words or phrases, the time required for such search depends on the weight of the data for search. Therefore, in this form, correspondence information is generated separately from the data for search, and the correspondence information is referred to as necessary, as mentioned above. This reference structure reduces the volume of data for search while guaranteeing the function of teaching the user the correspondence between keywords and related phrases. The search time can be shortened when searching for words or phrases used in the electronic manual 60. This can ultimately contribute to improved responsiveness.

The creation of the correspondence information shown in this second form is optional. In other words, it is possible to provide a configuration that does not generate such correspondence information. In that case, the search program should be changed as follows. Therefore, if a related phrase is hit in a search, the related phrase should be used as a guide to ascertain the keywords to be highlighted. Alternatively, when a related phrase is hit in a search, the phrase following the related phrase may be configured to be highlighted within a predetermined range.

### Third Embodiment

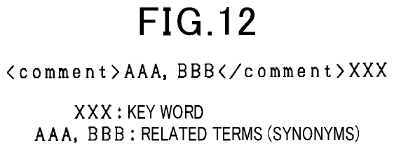

FIG. 12 illustrates the third embodiment. In addition to the various structural tags (e.g., header tag T1 and paragraph tag T2) described above, html has a comment tag as one of the existing tags. This comment tag consists of a <comment> as the start tag and a </comment> as the end tag. The text data tagged between (embedded by) those start and end tags is specified to be excluded from display by the browser when browsing. In this third embodiment, this comment tag is used as a special tag.

Specifically, as shown in FIG. 12, the related terms are embedded between <comment> and </comment>, and the comment tags are structured so that the related terms are aligned before and after the relevant keywords. For more information, comment tags are placed just before the keywords. When generating data for search from the source code of the electronic manual data in the processing for search in CPU 42, the related words or phrases tagged with the comment tags are extracted along with the keywords. In case you are wondering, this comment tag can also be placed immediately after the keyword .

One of the purposes of using comment tags is for the author of the source code to leave a note to facilitate the author's own and others' understanding. If text data in comment tags is uniquely extracted for such general use, the volume of data for search becomes bulky. Therefore, this third embodiment is configured to divide comment tags subject to text extraction by their placement. Specifically, comment tags tagged with structural tags such as the header tag T1 and the paragraph tag T2 are restricted to be used for text extraction.

In order to reduce the increase in data volume of search data, tags for comments and tags for embedding related phrases can be provided separately. This also allows the latter to be the target of text extraction.

### Fourth Embodiment

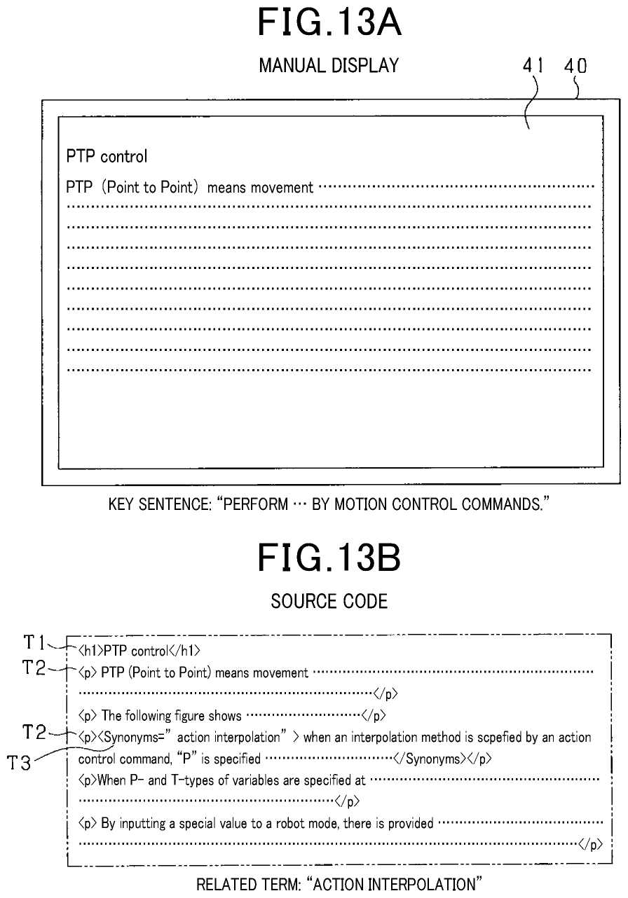

FIG. 13 illustrates the fourth embodiment. For the search box SB shown in the first form, etc., it is possible to input not only words but also sentences (sentences). However, when sentences are input, even if some of them are different, it is judged as a discrepancy. Therefore, the sentence input method is less likely to result in a hit in a search than is the case when a word is entered. Under these circumstances, it is assumed that when performing a search, a single word summarizing the sentence to be searched for may be specified as the search target. One of the features of this fourth embodiment is that it is devised in consideration of these circumstances. The following is an explanation of the above devices, focusing on the differences from the first form.

As shown in FIG. 13, the electronic manual 60 in this form describes the complementary methods in the motion control of the robot 20 as follows. That is, it states, “When specifying the completion method in the operation control command, if [P] is specified, PTP operation is performed.” The source code of the electronic manual 60 includes an “operation completion” associated with this sentence. Specifically, when specifying the completion method for source code with the <Synonyms=“operation completion”> operation control command, the PTP operation is performed if [P] is specified. It is stated as </Synonyms>. Therefore, although the related term in source code “motion complement” and the key sentence “When specifying the completion method in the motion control command, specifying [P] will cause a PTP operation.”, are listed alongside, only the relevant key sentences are displayed when browsing. When generating data for search, the relevant key sentences and related words or phrases are extracted.

In this way, words summarizing key sentences into words are included in the source code as related phrases. This ensures that key sentences related to the word are not omitted from the search, even if the user specifies the word and performs a search.

### Other Embodiments

The configuration for each of the above-mentioned embodiments is not limited to the descriptions above, but may be implemented, for example, as follows. For example, each of the following configurations may be applied individually to each of the above forms, or may be applied to each of the above forms in part or in whole in combination. It is also possible to arbitrarily combine all or some of the various configurations shown in each of the above forms. In this case, it is preferable that the technical significance (effect to be demonstrated) of each configuration subject to the combination is ensured.

In each of the above embodiments, a configuration in which the search program is installed in advance (e.g., at the time of manufacture) in the teaching pendant 40, which is the “operation terminal,” is exemplified, but is not limited to this configuration. For example, a program for setting up the robot's operation and viewing/searching electronic manuals 60 can be installed on a tablet or PC owned by the user. This allows those tablets and other devices to be used as operating terminals.

It may also be configured to download the electronic manual 60 from a server or the like to the teaching pendant 40 based on user operations (e.g., initial setup operation, manual update operation, viewing operation, etc.).

In each of the above embodiments, the teaching pendant 40 is configured to extract text data from the source code of the electronic manual 60 to generate data for search, and to search for words and/or phrases specified by the user from the data for search. The subject of generation of data for search and the word search are not limited to the teaching pendant 40. For example, when a user performs a search operation for a word or phrase, the system can be configured to generate data for the search and search for the word or phrase on the Internet (e.g., on a cloud server) based on the search operation, and to display the search results on the teaching pendant 40.

In each of the above embodiments, the configuration is such that data for search is generate by triggering the operation of the execution button BI (search operation), but this is not limited to this configuration. It is also possible to set the timing for the generation of data for search prior to the search operation. For example, the search data may be configured to be generated by triggering a user operation that is assumed to be performed prior to the search operation (specifically, an operation to view the electronic manual 60 or an operation to switch to the search screen display).

In each of the above embodiments, the keywords and related words and/or phrases associated with the keywords are placed in the same paragraph. Alternatively, the placement of related words or phrases (or terms) may be modified as follows. In other words, a related word or phrase (or term) for the keyword may be placed immediately before or after the paragraph containing the keyword.

In each of the above embodiments, a related word or phrase of the keyword is placed immediately before the keyword, but this is not limited to this placement. A related word or phrase for the keyword may be placed immediately after the keyword.

In each of the above embodiments, when a word or phrase specified by the user matches a related word or phrase, the system is configured to inform the user of the keywords associated with the related word or phrase (specified word or phrase). The specifics of this information are arbitrary. For example, it may be configured such that keywords and related words or phrases (specified words or phrases) are displayed together on the screen showing search results.

The process of generating data for search (i.e. data to be searched) shown in each of the above embodiments may be divided into two stages. Specifically, the first stage of processing extracts only the text data to be displayed and generates data for the primary search. If the specified word or phrase is not found in the primary search data, the text data to be displayed and the text data not to be displayed are extracted and secondary search data is generated as the second stage of processing.

In each of the above embodiments, the configuration of embedding words as related phrases in the source code is exemplified, but is not limited to this example. It can also be configured to embed sentences as related phrases in the source code.

In each of the above embodiments, the configuration is to highlight words that hit in the search or words related thereto, but this can also be changed. For example, it may be configured to highlight the entire paragraph containing the hit or related words or phrases.

In each of the above embodiments, the source code of the electronic manual 60 is described in the html format, but it is not limited to such description. For example, the source code for the electronic manual 60 may be described in an XML format.

In each of the above embodiments, the robot system 10 has an electronic manual 60 that contains electronic information on the handling instructions of the robot system 10, and the electronic manual has a word-search function. This is just one example and can be implemented with variations. For example, the same search function for the electronic manual 60 may be applied to other industrial equipment (e.g., machining equipment such as NC milling machines). Such function may also be applied to other mechanical systems such as air conditioning systems, water heating systems, area monitoring systems, etc.

[For the Group of Inventions Extracted From the Above Embodiments]

The following is an explanation of the features of the group of inventions extracted from the above embodiments, showing the effects, etc., as necessary. In the following, for ease of understanding the invention, the corresponding components in the above embodiments are shown in parentheses. However, the components of the invention are not limited to the specific configurations shown in parenthesis, etc.

Feature 1 is provided such that robot system (a robot system 1), comprising:

an operation terminal (e.g., a teaching pendant 40), the operation terminal having a display and a controller, the display (a display 41) displaying an electronic manual (an electronic manual 60) based on a viewing operation of a user, the electronic manual being an instructional information for the robot system,

wherein the electronic manual is expressed and stored by a source code written in markup language (e.g., html), the source code including i) text data subject to display, which consists of words or phrases to be displayed on the display by the viewing operation, and ii) text data not subject to display, consisting of related words or phrases (a horizontally articulated robot or a SCARA robot) associated with specific words or phrases (e.g., a 4-axis robot) included in the text data subject to display, the text data not subject to display being not displayed on the display by the viewing operation, and

the controller is configured to, when a user of the robot system performs a search operation for a specified word or phrase on the electronic manual, i) extract data for search from the source code, the data for search including the text data subject to display and the text data not subject to display, ii) search the data for search for the specified word or phrase, and iii) display a result of the search on the display.

The source code for the electronic manual shown in this feature is described with markup language. This source code contains text data to be displayed when viewed and text data not to be displayed when viewed. When the user performs a search operation for a word or phrase, the word or phrase specified by the user is searched from the search data, which consists of text data to be displayed and text data not to be displayed extracted from the source code. Some of the various components of the robot system are referred to by special terms such as technical terms (equivalent to specific words and/or phrases in the text data to be displayed). Therefore, there is not necessarily widespread uniformity regarding the terminology concerned. The text data not subject to display shown in this feature is text data consisting of related words and/or phrases associated with the above specific words and phrases. Even if a user specifies not a specific word or phrase but a related word or phrase as a search candidate, the related word or phrase is included in the search data. This reduces or prevents such words from being omitted from the search (or retrieval). In other words, even though the electronic manual contains information that meets the user's objectives, the information can be prevented or reduced from being leaked from the search. For these reasons, the system can contribute to further improving the convenience of robot system operation.

Furthermore, text data not subject to display will not be displayed when viewing the electronic manual. This avoids making the electronic manual difficult to read when browsing or viewing, even if it is configured to embed (arrange) related words and/or phrases in the source code.

Feature 2 is provided such that a robot system (a robot system 10), comprising:

an operation terminal (e.g., a teaching pendant 40), the operation terminal having a display (e.g., a display 41), the display displaying an electronic manual (e.g., an electronic manual 60) based on a viewing operation of a user, the electronic manual being an instructional information for the robot system,

wherein the electronic manual is expressed and stored by a source code written in markup language, the source code including i) text data subject to display, which consists of words or phrases to be displayed on the display by the viewing operation, and ii) text data not subject to display, consisting of related words or phrases (e.g., a horizontally articulated robot or a SCARA robot) associated with specific words or phrases (e.g., a 4-axis robot) included in the text data subject to display, the text data not subject to display being not displayed on the display by the viewing operation, and

the operation terminal comprises data generating means 42A (e.g., a functional means functionally realized by data extraction and converting process carried out by a CPU 42) for extracting both the text data subject to display and the text data not subject to display, from the source code of the electronic manual and generating data for search;

search means 42B (e.g., a functional means functionally realized by a search process carried out by a CPU 42) for searching the data for search, for a word or phrase specified by a user, when the user performs a search operation for the word or phrase in the electronic manual; and

report means 42C (e.g., a functional means functionally realized by report of search results carried out by a CPU 42) for reporting a search result performed by the search means, to the user by displaying the search result on the display.

According to the search system shown in Feature 2, the same effects as those shown in Feature 1 can be expected. In other words, it can reduce or prevent the leakage of information from the search even though the electronic manual contains information that meets a user's objective, and contribute to improving the convenience of the robot system.

In addition, because search data is generated as needed from the electronic manual, there is no need to separately prepare search data in the ROM of the operation terminal or other devices. In this way, the increase in data volume can be suppressed, which is desirable for coexistence with other functions in the operating terminal (e.g., the robot motion setting function). If the electronic manual is revised in accordance with updates to the robot system, the revised results will also be reflected in the inspection data generated from the electronic manual. This is desirable for proper search for the robot system and electronic manual versions.

Feature 3 is provided with the robot system according to the feature 1 or 2 such that

the source code includes tags for storing words or phrases (e.g., a header tag T1, a paragraph tag T2, a special tag T3) composing the both the text data subject to display and the text data not subject to display;

the tags include a first tag (e.g., the header tag T1, the paragraph tag T2) and a second tag (e.g., the special tag T3), wherein the first tag specifies sentence structures in the electronic manual and the second tag specifies avoiding at least part of the words or phrases stored in the electronic manual, from being subjected to display, when the electronic manual is displayed on the display responsively to the viewing operation;

the related word or phrase is embedded by the second tag; and

the data for search are generated by extracting, from the source code, each of the words or phrases tagged with the first tag and the second tag.

The source code contains a first tag that defines the sentence structure and a second tag that regulates the display of words or phrases. By extracting the words or phrases tagged with those first and second tags from the source code, data for search (i.e., data to be searched) can be formed without excesses or deficiencies.

Feature 4 is provided with the robot system according to the feature 1 or 2 such that:

the data for search is formed in such a way that the text data for non-display extracted from the source code and the text data for display extracted from the source code can be distinguished in the data for search.

Thanks to this distinguishment, the search enables identification of which word or phrase, which has been hit, belongs to the text data to be displayed or the text data not to be displayed. This is desirable to achieve a configuration that appropriately informs the user of the search results.

Feature 5 is provided with the robot system according to the feature 1 or 2 such that

the source code includes tags (e.g., a header tag T1, a paragraph tag T2, a special tag T3) for tagging words or phrases composing the both the text data subject to display and the text data not subject to display;

the tags include a first tag (e.g., a header tag T1, a paragraph tag T2) and a second tag (e.g., a spatial tag T3), wherein the first tag specifies sentence structures in the electronic manual and the second tag specifies avoiding at least part of the words or phrases stored in the electronic manual, from being subjected to display, when the electronic manual is displayed on the display responsively to the viewing operation;

the related word or phrase is embedded by the second tag, the second tag being embedded by the first tag together with the related word or phrase embedded by the second tag; and

the data for search are generated by extracting, from the source code, each of the words or phrases tagged with the first tag, the second tag, and the word or phrase tagged with the second tag.

As shown in this feature, the second tag is embedded in the first tag, and the second tag is extracted for each word embedded in the first tag to generate data for search. This allows the second tag to be used as an indicator to identify the text data to be displayed and the text data not to be displayed in the data for search. The technical idea shown in Feature 4 can be suitably realized.

Feature 6 is provided with the robot system according to any one of the features 1-5 such that:

the report means is configured to report the search result in a first report mode or a second report mode, wherein

the first report mode is provided such that,

when the user specifies any of the special words or phrases in the search, a location of the specified word or phrase in the electronic manual is reported to the user, and

the second report mode is provided such that,

when the user specifies any of the related words or phrases in the search, a location of a word and phrase to which the specified word or phrase is related in the electronic manual is reported to user.

When the search results are reported, if a word or phrase displayed at the time of browsing hits the search, the location (i.e., address) of the word or phrase in the electronic manual is informed to the user. If a word or phrase that is not displayed when browsing hits the search, the user is informed by the location of the word or phrase associated with that word or phrase in the electronic manual. This can largely improve the convenience of the search function.

Feature 7 is provided with the robot system according to the feature 6 such that:

in the source code of the electronic manual, the related word or phrase is arranged to be in line with the specific word or phrase just before or just after a word or phrase related to the related word or phrase in the specific words and phrase,

the date for search is formed to maintain a back and forth relationship between the specific word or phrase and the related word or phrase, and

the second report mode is configured to report the user of the specific word or phrase which is located before or after a word or phrase which is among the related words or phrases and specified by the user in the search.

In the configuration shown in this feature, the data for detection is formed by placing (co-locating) a related word or phrase immediately before or after a specified word or phrase, and maintaining the back-and-forth relationship between the specific word or phrase and the related word or phrase. In this case, when a related phrase is hit by search, the corresponding specific phrase is positioned immediately before or after the specified word or phrase. This simplifies the report of the location realized by the second notification mode. The specified word or phrase to be reported can be easily understood by using the related word or phrase as a guide.

For example, it may be configured as follows: “When a related word or phrase is hit in the search and the result of the search is displayed, a relevant part of the electronic manual is displayed with a display style of the specified word or phrase in line with the related word or phrase changed.

Feature 8 is provided by a search system which searches a word or phrase, specified by user, from an electronic manual (e.g., an electronic manual 60 provided for a robot system (e.g., a robot system 10). The robot system includes an operation terminal (e.g., a teaching pendant 40) which is used a user's viewing operation to display the electronic manual on a display (e.g., a display 41). The electronic manual is expressed and stored by a source code written in markup language, the source code including i) text data subject to display, which consists of words or phrases to be displayed on the display by the viewing operation, and ii) text data not subject to display, consisting of related words or phrases (e.g., a horizontally articulated robot or a SCARA robot) associated with specific words or phrases (e.g., a 4-axis robot) included in the text data subject to display, the text data not subject to display being not displayed on the display by the viewing operation. The search system includes data generating means 42A (e.g., a functional means functionally realized by data extraction and converting process carried out by a CPU 42) for extracting both the text data subject to display and the text data not subject to display, from the source code of the electronic manual and generating data for search; search means 42B (e.g., a functional means functionally realized by a search process carried out by a CPU 42) for searching the data for search, for a word or phrase specified by a user, when the user performs a search operation for the word or phrase in the electronic manual; and report means 42C (e.g., a functional means functionally realized by report of search results carried out by a CPU 42) for reporting a search result performed by the search means, to the user by displaying the search result on the display.

According to the search system shown in this feature 8, the same effects as those shown in Feature 1 can be expected.

Feature 9 is provided as a program for searching a word or phrase specified by a user in an electric manual (an electronic manual 60). The electronic manual is provided for a robot system (a robot system 10) having an operation terminal (e.g., a teaching pendant 40) directed to the robot system. A user's viewing operation on the operating terminal allows a display (e.g., a display 41) of the operation terminal to display searched information thereon. The program stored in a non-transient computer-readable recording medium (e.g., a ROM 45) and, when being read from the medium, enables a computer (e.g., a CPU 42) to functionally realize the data generating means 42A, the search means 42B, and the report means 42C, which are described with, for example, the feature 8.

According to this feature 9, the same effects as those shown in Feature 1 or other features can be expected.

Feature 10 is directed to an industrial equipment system provided with an operation terminal (e.g., a teaching pendant 40 or a computer denoted by PC), the operation terminal having a display (e.g. a display 41), the display displaying an electronic manual based on a viewing operation of a user, the electronic manual being an instructional information for the industrial equipment system. Hence, the electronic manual according to the feature 2, for example, can be practiced with the industrial equipment system of the feature 10.

Similarly to the electronic manual for the robot system, some of the various configurations that make up the industrial equipment system are referred to by special terms such as technical terms (equivalent to specific words and/or phrases in the text data to be displayed), and such terms are not always widely standardized. In view of such conditions, the foregoing various new tag-used manual structures can also be effective for the industrial equipment systems other than the foregoing robot system, as described with the features 1 and 2.

1-6. (canceled)

7. A robot system, comprising:
an operation terminal, the operation terminal having a display and a controller, the display displaying an electronic manual based on a viewing operation of a user, the electronic manual being an instructional information for the robot system,
wherein the electronic manual is expressed and stored by a source code written in markup language, the source code including i) text data subject to display, which consists of words or phrases to be displayed on the display by the viewing operation, and ii) text data not subject to display, consisting of related words or phrases associated with specific words or phrases included in the text data subject to display, the text data not subject to display being not displayed on the display by the viewing operation, and
the controller is configured to, when a user of the robot system performs a search operation for a specified word or phrase on the electronic manual, i) extract data for search from the source code, the data for search including the text data subject to display and the text data not subject to display, ii) search the data for search for the specified word or phrase, and iii) display a result of the search on the display.

8. A robot system, comprising:
an operation terminal, the operation terminal having a display, the display displaying an electronic manual based on a viewing operation of a user, the electronic manual being an instructional information for the robot system,
wherein the electronic manual is expressed and stored by a source code written in markup language, the source code including i) text data subject to display, which consists of words or phrases to be displayed on the display by the viewing operation, and ii) text data not subject to display, consisting of related words or phrases associated with specific words or phrases included in the text data subject to display, the text data not subject to display being not displayed on the display by the viewing operation, and
the operation terminal comprises data generating means for extracting both the text data subject to display and the text data not subject to display, from the source code of the electronic manual and generating data for search;
search means for searching the data for search, for a word or phrase specified by a user, when the user performs a search operation for the word or phrase in the electronic manual; and
report means for reporting a search result performed by the search means, to the user by displaying the search result on the display.

9. A robot system according to claim 7, wherein
the source code includes tags for storing words or phrases composing the both the text data subject to display and the text data not subject to display;
the tags include a first tag and a second tag, wherein the first tag specifies sentence structures in the electronic manual and the second tag specifies avoiding at least part of the words or phrases stored in the electronic manual, from being subjected to display, when the electronic manual is displayed on the display responsively to the viewing operation;
the related word or phrase is embedded by the second tag, the second tag being embedded by the first tag together with the related word or phrase embedded by the second tag; and
the data for search are generated by extracting, from the source code, each of the words or phrases tagged with the first tag, the second tag, and the word or phrase tagged with the second tag.

10. A robot system according to claim 7, wherein the report means is configured to report the search result in a first report mode or a second report mode, wherein
the first report mode is provided such that,
when the user specifies any of the special words or phrases in the search, a location of the specified word or phrase in the electronic manual is reported to the user, and
the second report mode is provided such that,
when the user specifies any of the related words or phrases in the search, a location of a word and phrase to which the specified word or phrase is related in the electronic manual is reported to user.

11. A robot system according to claim 10, wherein, in the source code of the electronic manual, the related word or phrase is arranged to be in line with the specific word or phrase just before or just after a word or phrase related to the related word or phrase in the specific words and phrase,
the date for search is formed to maintain a back and forth relationship between the specific word or phrase and the related word or phrase, and
the second report mode is configured to report the user of the specific word or phrase which is located before or after a word or phrase which is among the related words or phrases and specified by the user in the search.

12. A robot system according to claim 9, wherein the report means is configured to report the search result in a first report mode or a second report mode, wherein
the first report mode is provided such that,
when the user specifies any of the special words or phrases in the search, a location of the specified word or phrase in the electronic manual is reported to the user, and
the second report mode is provided such that,
when the user specifies any of the related words or phrases in the search, a location of a word and phrase to which the specified word or phrase is related in the electronic manual is reported to user.

13. A robot system according to claim 8 wherein
the source code includes tags for storing words or phrases composing the both the text data subject to display and the text data not subject to display;
the tags include a first tag and a second tag, wherein the first tag specifies sentence structures in the electronic manual and the second tag specifies avoiding at least part of the words or phrases stored in the electronic manual, from being subjected to display, when the electronic manual is displayed on the display responsively to the viewing operation;
the related word or phrase is embedded by the second tag, the second tag being embedded by the first tag together with the related word or phrase embedded by the second tag; and
the data for search are generated by extracting, from the source code, each of the words or phrases tagged with the first tag, the second tag, and the word or phrase tagged with the second tag.

14. A robot system according to claim 8 wherein the report means is configured to report the search result in a first report mode or a second report mode, wherein
the first report mode is provided such that,
when the user specifies any of the special words or phrases in the search, a location of the specified word or phrase in the electronic manual is reported to the user, and
the second report mode is provided such that,
when the user specifies any of the related words or phrases in the search, a location of a word and phrase to which the specified word or phrase is related in the electronic manual is reported to user.

15. A robot system according to claim 14 wherein, in the source code of the electronic manual, the related word or phrase is arranged to be in line with the specific word or phrase just before or just after a word or phrase related to the related word or phrase in the specific words and phrase,
the date for search is formed to maintain a back and forth relationship between the specific word or phrase and the related word or phrase, and
the second report mode is configured to report the user of the specific word or phrase which is located before or after a word or phrase which is among the related words or phrases and specified by the user in the search.

16. A robot system according to claim 13 wherein the report means is configured to report the search result in a first report mode or a second report mode, wherein
the first report mode is provided such that,
when the user specifies any of the special words or phrases in the search, a location of the specified word or phrase in the electronic manual is reported to the user, and
the second report mode is provided such that,
when the user specifies any of the related words or phrases in the search, a location of a word and phrase to which the specified word or phrase is related in the electronic manual is reported to user.
